(19) United States
(12) Patent Application Publication
(10) Pub. No.: US 2007/0130303 A1
(43) Pub. Date: Jun. 7, 2007

(54) Apparatus, system, and method for recovering messages from a failed node

(76) Inventors: Gary Anna, Tucson, AZ (US); Ralph Thomas Beeston, Tucson, AZ (US); Joseph Whitney Dain, Tucson, AZ (US); Gregory Tad Kishi, Oro Valley, AZ (US)

Correspondence Address: KUNZLER & ASSOCIATES, 8 EAST BROADWAY, SUITE 600, SALT LAKE CITY, UT, 84111, US

(21) Appl. No.: 11/281,630

(22) Filed: Nov. 17, 2005

(51) Int. Cl. G06F 15/173

(52) U.S. Cl. 709/223

(57) ABSTRACT

An apparatus, system, and method are disclosed for recovering a message from a failed node. A message module communicates a message to a request queue and a copy queue. A transfer module transfers the message from the request queue to a first target node in response to the message residing in the request queue. A detection module detects a failure of the first target node. A recovery module copies the message from the copy queue to the request queue in response to the failure of the first target node and the message residing in the copy queue. The transfer module further transfers the message from the request queue to a second target node in response to the message residing in the request queue.

### BACKGROUND OF THE INVENTION

1. Field of the Invention

This invention relates to recovering messages from a failed processing node and more particularly relates to recovering messages in a distributed queuing environment.

2. Description of the Related Art

Data processing systems that handle large numbers of transactions often employ a plurality of processing nodes herein referred to as nodes to execute transactions. Each node may comprise processing logic as is well known to those skilled in the art. For example, a data processing system with a plurality of storage devices and/or storage libraries may employ a plurality of nodes to store data to and retrieve data from the storage devices and/or storage libraries. The nodes of the data processing system may be widely physically and/or logically distributed. For example, a node may be remotely located from one or more elements of the data processing system and may communicate with the data processing system over a communications channel such as a packet-switched network.

Each node may be configured to execute one or more transactions independently of other nodes. A node may receive the one or more transactions as a message. The message as used herein includes one or more transactions that may comprise an atomic operation. The transactions of the atomic operation must be executed as a group and cannot be divided between nodes. A node may receive a message, execute the transactions embodied in the message, and communicate the execution status of the message. For example, a node may receive a message to store a data block to a specified location in a storage device, store the data block, and communicate that the data block is successfully stored.

The data processing system may distribute messages to nodes using a queuing system. In one embodiment, the data processing system communicates a message to a request queue. One of the plurality of nodes in the data processing system reads the message from the request queue, transferring the message to the reading node. The reading node executes the message and communicates that the message is executed. Unfortunately, if a node of the data processing system fails, any messages transferred to the failed node are not executed.

From the foregoing discussion, it should be apparent that a need exists for an apparatus, system, and method that recover a message from a failed node. Beneficially, such an apparatus, system, and method would support the redistribution of messages from failed nodes in a multi-node distributed queuing environment.

### SUMMARY OF THE INVENTION

The present invention has been developed in response to the present state of the art, and in particular, in response to the problems and needs in the art that have not yet been fully solved by currently available message recovery methods. Accordingly, the present invention has been developed to provide an apparatus, system, and method for recovering a message from a failed node that overcome many or all of the above-discussed shortcomings in the art.

The apparatus to recover a message from a failed node is provided with a plurality of modules configured to functionally execute the steps of communicating a message to a request queue and a copy queue, transferring the message from the request queue to a first target node, detecting a failure of the first target node, copying the message from the copy queue to the request queue, and transferring the message from the request queue to a second target node. These modules in the described embodiments include a message module, a transfer module, a detection module, and a recovery module.

The message module communicates a message to a request queue and a copy queue. The message comprises one or more transactions comprising an operation. Any target node of a plurality of target nodes in a distributed data processing system may execute the message.

The transfer module transfers the message from the request queue to a first target node in response to the message residing in the request queue. In one embodiment, the transfer module reads or pulls the message from the request queue. The transfer module may also remove the message from the request queue. In an alternate embodiment, the transfer module transfers the message to the first target node by communicating the message to the first target node and removing the message from the request queue.

In a certain embodiment, the transfer module transfers the message to a first message table for the first target node. In one alternate embodiment, there is a copy queue for each target node and the message module communicates the message to a first copy queue for the first target node in response to the transferring the message from the request queue to the first target node.

The detection module detects a failure of the first target node. In one embodiment, each target node in the distributed data processing system includes an instance of the detection module. The detection module may detect the failure if the first target node fails to respond to a communication.

The recovery module copies the message from the copy queue to the request in response to the failure of the first target node and the message residing in the copy queue. Each target node in the distributed data processing system may include an instance of the recovery module. In one embodiment, the recovery module copies the message from the copy queue to the request queue in response to the message residing in the copy queue, the message not residing in the request queue, and the message not residing in a message table for a target node other than the first target node such as a second message table for a second target node.

In an alternate embodiment, the recovery module copies the message from the first copy queue to the request queue in response to the message residing in the first copy queue for the first target node and not residing in the request queue. The apparatus recovers the message from the failed first target node and transfers the message to the second target node.

A system of the present invention is also presented to recover a message from a failed node. The system may be embodied a distributed data processing system. In particular, the system, in one embodiment, includes a source node, and a plurality of target nodes including a first and second target node. The source node includes a request queue, a copy queue, a message module, and a reply queue. Each target node includes a transfer module, a detection module, a recovery module, and an execution module.

The source node is configured to distribute a message to the plurality of target nodes. The message module communicates the message to the request queue and the copy queue. The request queue stores messages that are awaiting distribution to a target node. The copy queue stores messages that are not executed including messages awaiting distribution and messages that are distributed to a target node.

The transfer module of the first target node transfers the message from the request queue to the first target node in response to the message residing in the request queue. The transfer module of any target node may transfer the message. The detection module of the second target node detects a failure of the first target node. The recovery module of the second target node copies the message from the copy queue to the request queue in response to the failure of the first target node and the message residing in the copy queue. The transfer module of the second target node transfers the message from the request queue to the second target node in response to the message residing in the request queue. The execution module of the second target node may execute the message and communicates the message to the reply queue. The system supports the recovery of messages from failed nodes in distributed data processing systems.

A method of the present invention is also presented for recovering a message from a failed node. The method in the disclosed embodiments substantially includes the steps to carry out the functions presented above with respect to the operation of the described apparatus and system. In one embodiment, the method includes communicating a message to a request queue and a copy queue, transferring the message from the request queue to a first target node, detecting a failure of the first target node, copying the message from the copy queue to the request queue, transferring the message from the request queue to a second target node, and executing the message.

A message module communicates a message to a request queue and a copy queue. A transfer module transfers the message from the request queue to a first target node in response to the message residing in the request queue. A detection module detects a failure of the first target node. A recovery module copies the message from the copy queue to the request queue in response to the failure of the first target node and the message residing in the copy queue. The transfer module further transfers the message from the request queue to a second target node in response to the message residing in the request queue. An execution module of the second target node executes the message. The method recovers the message from the failed first target node to the second target node and completes execution with the second target node.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention recovers a message from a first failed target node and transfers the message to a second target node. In addition, the embodiment of the present invention may complete the execution of the message using the second target node. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a distributed data processing system in accordance with the present invention;

FIG. 2 is a schematic block diagram illustrating one embodiment of a source node of the present invention;

FIG. 3a is a schematic block diagram illustrating one embodiment of a target node of the present invention;

FIG. 3b is a schematic block diagram illustrating one alternate embodiment of a target node of the present invention;

FIG. 4 is a schematic block diagram illustrating one alternate embodiment of a source node of the present invention;

FIG. 5 is a schematic block diagram illustrating one embodiment of a node of the present invention;

FIGS. 6a-6b are a schematic flow chart diagram illustrating one embodiment of a recovery method of the present invention;

FIGS. 7a-7b are a schematic flow chart diagram illustrating one alternate embodiment of a recovery method of the present invention; and

FIGS. 8a-8d are schematic block diagrams illustrating one embodiment of message recovery of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

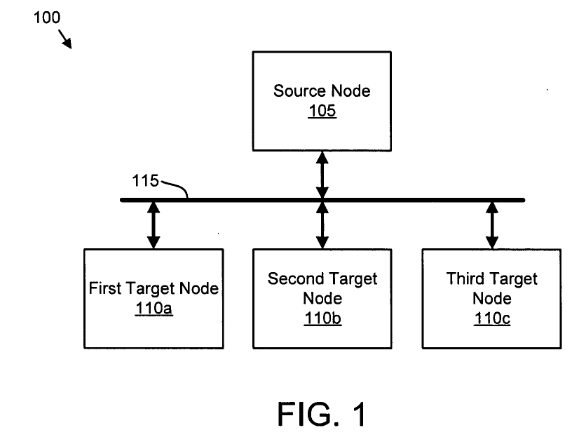

FIG. 1 is a schematic block diagram illustrating one embodiment of a distributed data processing system 100 in accordance with the present invention. The system 100 includes a source node 105 and one or more target nodes 110. Although for simplicity the system is depicted with on source node 105, and three target nodes 110, any number of source nodes 105 and target nodes 110 may be employed.

The source node 105 is configured to distribute a message to the target nodes 110 as will be discussed hereafter. The message includes one or more transactions that comprise an operation. In one embodiment, the operation is an atomic operation that must be processed by a single target node 110.

The source node 105 distributes the message to a target node 110, and the target node 110 executes the message and communicates that the message is executed to the source node. The source node 105 and the target nodes 110 communicate over a communications medium 115. The communications medium 115 maybe a packet-switched network such as the Internet, a wide-area network, a local-area network, a dedicated digital bus, or the like including combinations of one or more communications mediums 115. For example, the source module 105 may communicate with the first and second target nodes 110a, 110b over a dedicated digital bus and communicate with the third target node 110c over the Internet.

In one embodiment, the system 100 is configured as a storage system with the source node 105 distributing messages comprising transactions for storage devices and/or storage libraries. For example, source node 105 may distribute a message to the third target node 110c to retrieve data from a storage device (not shown). The third target node 110c may execute the message, retrieving the data. The distributed organization of the system 100 allows the plurality of target nodes 110 to independently execute messages without the potential bottlenecks of inter-target node 110 communication or coordination.

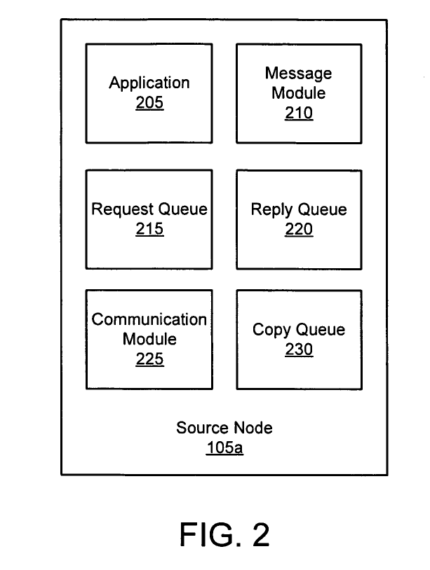

FIG. 2 is a schematic block diagram illustrating one embodiment of a source node 105a of the present invention. The source node 105a includes an application 205, message module 210, request queue 215, reply queue 220, communication module 225, and car copy queue 230. The description of the source node 105a refers to elements of FIG. 1, like numbers referring to like elements.

In the depicted embodiment, the application 205 executes on the source node 105a. In an alternate embodiment, the application 205 executes remotely and communicates with the source node 105a. The application 205 requests that the source node 105a execute one or more transactions. The message module 210 organizes the transactions into a message. The transactions may store data to and/or retrieve data from a storage device and/or storage library. The message module 210 communicates the message to the request queue 215 and the copy queue 230.

The request queue 215 stores undistributed messages. In one embodiment, the request queue 215 is organized as data storage for the message as is well known to those skilled in the art. Messages in the request queue 215 may be organized on a first-in first-out (“FIFO”) basis, on a priority basis, on an execution-time estimate basis, or the like. For example, the request queue 215 may store messages on a FIFO basis in the order each message is received. Each message may be stored in a data array and linked to a previous and a subsequent message. A first message received from the message module 210 prior to a second message may also be transferred from the request queue 215 prior to the second message.

The copy queue 230 stores unexecuted messages. In one embodiment, the copy queue 230 is also organized as data storage. The copy queue 230 may be further organized as a searchable list of messages. The reply queue 220 stores executed messages and may be organized as data storage. The request queue 215, reply queue 220, and/or copy queue 230 may store identifiers for messages or complete messages. The communication module 225 may communicate with one or more target nodes 110 over a communications medium 115.

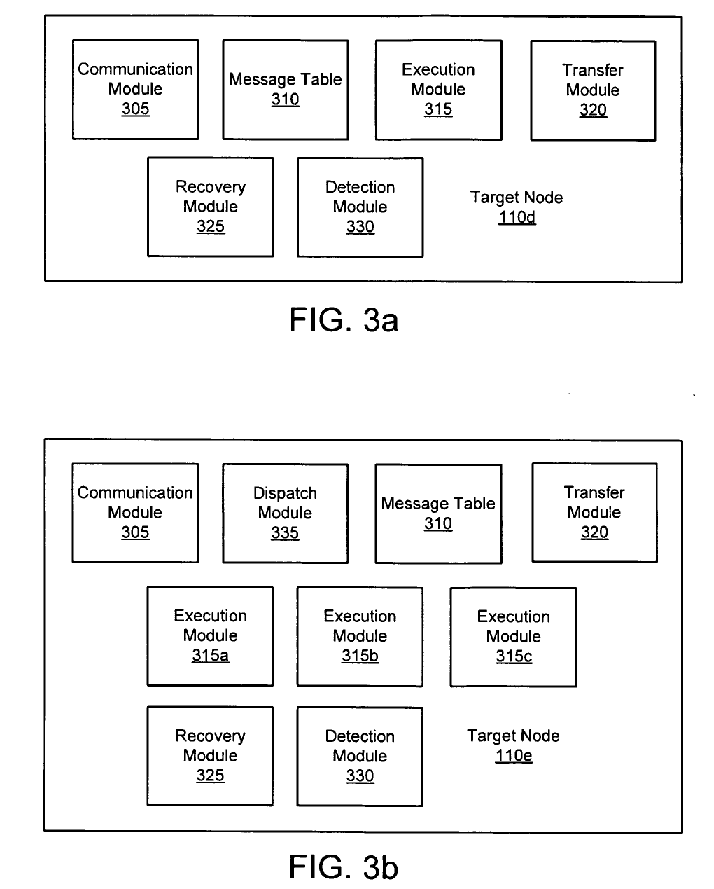

FIG. 3a is a schematic block diagram illustrating one embodiment of a target node 110d of the present invention. The target node 110d includes a communication module 305, message table 310, execution module 315, transfer module 320, recovery module 325, and detection module 330. The description of the target node 110d refers to elements of FIGS. 1-2, like numbers referring to like elements.

The communications module 305 communicates with the source node 105 and one or more target nodes 110 over the communications medium 115. The transfer module 320 transfers a message from the request queue 215 to the target node 110d. In one embodiment, the transfer module 320 reads or pulls the message from the request queue 215 and removes the message from the request queue 215.

In one embodiment, the message table 310 stores each message that the transfer module 320 transfers to the target node 110d. The execution module 315 executes the messages transferred to the target node 110d. In one embodiment, the execution module 315 executes messages from the message table 310. For example, the execution module 315 may execute a message from the message table 310 reading the message from the message table 310 and by retrieving data from and/or storing data to a storage device as directed by the message.

The detection module 330 detects a failure of another target node 110. Each target node 110 may include an instance of the detection module 330. In one embodiment, the detection module 330 detects the failure if the other target node 110 does not respond to a query. In an alternate embodiment, the source node 105 notifies the detection module 330 of the failure. The recovery module 325 copies the message from the copy queue 230 to the request queue 215 in response to the failure of a target node 110 and the message residing in the copy queue 230.

FIG. 3b is a schematic block diagram illustrating one alternate embodiment of a target node 110e of the present invention. The target node 110e includes elements of FIG. 3a, like numbers referring to like elements. In addition, the target node 110e includes a dispatch module 335 and a plurality of execution modules 315.

The dispatch module 335 dispatches a message to an execution module 315. For example, the dispatch module 335 may communicate a message from the message table 310 to the first execution module 315a. In addition, the dispatch module 335 may track the status of the dispatched message.

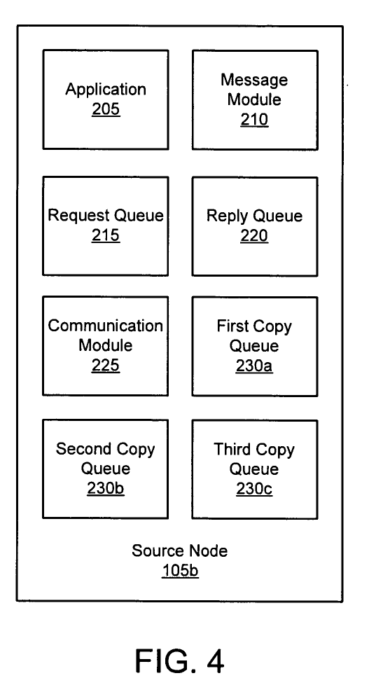

FIG. 4 is a schematic block diagram illustrating one alternate embodiment of a source node 105b of the present invention. The source node 105b includes elements of FIG. 2, like numbers referring to like elements. In addition, the source node 105b includes a plurality of copy queues 330. The description of the source node 105b further refers to elements of FIGS. 1 and 3a-3b, like numbers referring to like elements.

In one embodiment, the source node 105b includes a copy queue 330 corresponding to each target node 110 in the distributed data processing system 100 of FIG. 1. The message module 210 may copy the message to the copy queue 330 corresponding to a target node 110 when the transfer module 320 of the target node 110 transfers the message to the target node 110.

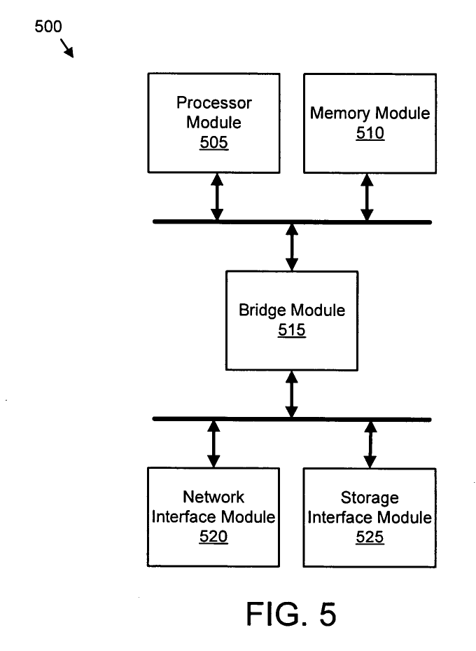

FIG. 5 is a schematic block diagram illustrating one embodiment of a node 500 of the present invention. The node 500 maybe the source node 105 of FIGS. 1-2, and 4 and/or the target node 110 of FIGS. 3a-3b. The node 500 includes a processor module 505, a memory module 510, a bridge module 515, and a network interface module 520. In one embodiment, the node 500 also includes a storage interface module 525. The description of the node 500 refers to elements of FIGS. 1-4, like numbers referring to like elements.

The processor module 505, memory module 510, bridge module 515, network interface module 520, and storage interface module 525 may be fabricated of semiconductor gates on one or more semiconductor substrates. Each semiconductor substrate may be packaged in one or more semiconductor devices mounted on circuit cards. Connections between the processor module 505, the memory module 510, the bridge module 515, the host interface module 520, and the storage interface module 525 may be through semiconductor metal layers, substrate to substrate wiring, or circuit card traces or wires connecting the semiconductor devices.

The memory module 510 stores software instructions and data. The processor module 505 executes the software instructions and manipulates the data as is well know to those skilled in the art. The processor module 505 communicates with the network interface module 520 and the storage interface module 525 through the bridge module 515. In one embodiment, the communications module 225 of FIGS. 2 and 4 and the communications module 305 of FIGS. 3a-3b include the network interface module 520. In addition, execution modules 315 of FIGS. 3a-3b may comprise the processor module 505 and the memory module 510.

In one embodiment, the memory module 510 stores and the processor module 505 executes one or more software processes comprising the message module 210, request queue 215, reply queue 220, and copy queue 230 of FIGS. 2 and 4. In an alternate embodiment, the software processes comprise the message table 310, transfer module 320, recovery module 325, and detection module 330 of FIGS. 3a-3b and the dispatch module 335 of FIG. 3b.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

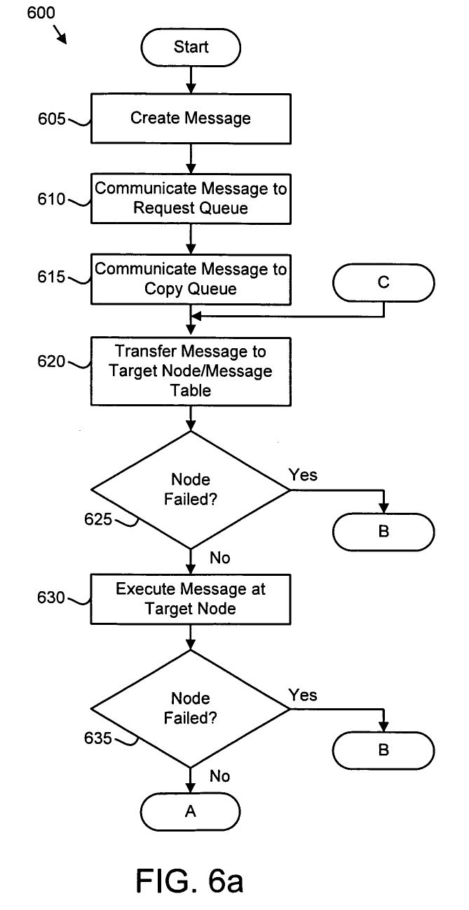

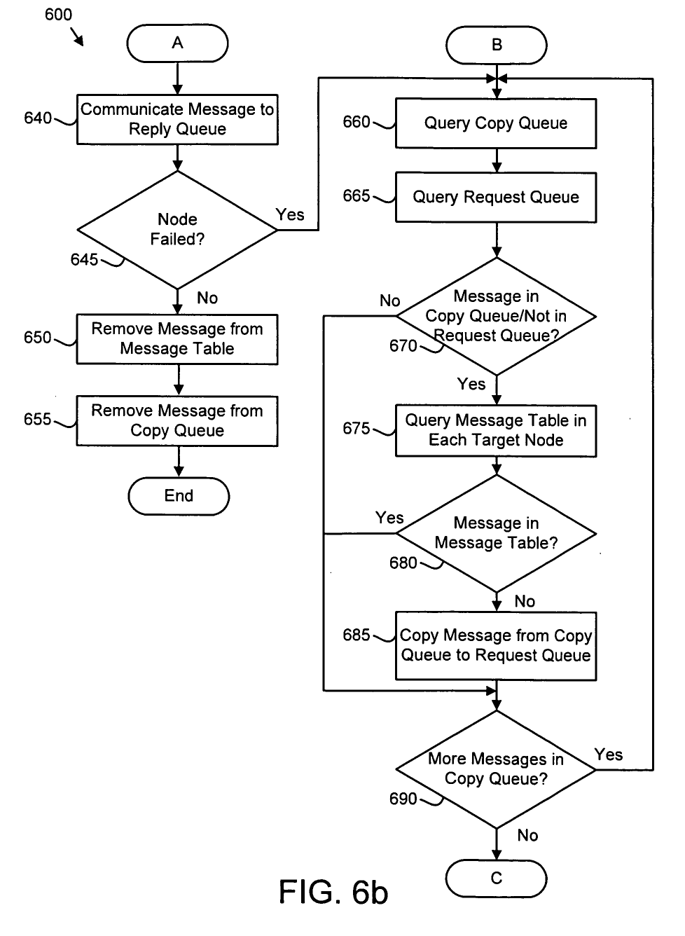

FIGS. 6a-6b are a schematic flow chart diagram illustrating one embodiment of a recovery method 600 of the present invention. The method 600 substantially includes the steps to carry out the functions presented above with respect to the operation of the described system 100 and nodes 105, 110, 500 of FIGS. 1-5. The description of the method 600 further refers to elements of FIGS. 1-5, like numbers referring to like elements.

The method 600 begins and in one embodiment, the message module 210 creates 605 a message. The message module 210 may create 605 the message in response to a request from the application 205. In one embodiment, the message includes a header that includes a message identifier and a time stamp. The message may also include one or more transactions. Each transaction may include one or more digital instructions such as processor instructions, script, or the like. In addition, the message may include data.

The message module 210 communicates 610 the message to the request queue 215. In addition, the message module 210 further communicates 615 the message to the copy queue 230. In one embodiment, the message module 210 writes the message to data address for the request queue 215 and/or copy queue 230. In an alternate embodiment, the message module 210 passes a pointer to the message to the request queue 215 and/or copy queue 230. In a certain embodiment, the message module 210 communicates 610/615 the message identifier for the message instead of communicating the entire message.

The transfer module 320 transfers 620 the message from the request queue 215 to a first target node 110a in response to the message residing in the request queue. In one embodiment, the transfer module 320 further transfers 620 the message to a message table 310 for the first target node 110a. In a certain embodiment, the transfer module 320 requests the message from the request queue 215. Allowing the transfer module 320 of each target node 110 to transfer the message serves to balance the message load among the target nodes 110 as a target node 110 may acquire a message when underutilized and refrain from acquiring a message when fully utilized.

The detection module 330 detects 625 if there is a failure of a target node 110. Although the detection module 330 may detect 625 a failure of any target node 110, for simplicity the description of method 600 focuses on the detection 625, 635, 645 of a first target node 110a. If the detection module 330 does not detect 625 a failure of the first target node 110a, an execution module 315 of the first target node 110a may execute 630 the message stored on the message table 310.

The detection module 330 again detects 635 if there is a failure of the first target node 110a. If the detection module 330 does not detect 635 the failure of the first target node 110a, the execution module 315 communicates 640 the message to the reply queue 220. The detection module 330 further detects 645 if there is a failure of the first target node 110. If the detection module 330 does not detect 645 the failure of the first target node 110, the execution module 315 may remove 650 the message from the message table 310. In addition, the message module 210 may remove 655 the message from the copy queue 230 in response to the reply queue 220 receiving the message and the method 600 terminates. In one embodiment, the message module 210 removes 655 the message by finding an instance of the message stored on the copy queue 230 and deleting the instance. For example, if the reply queue 220 receives a first message, the message module 210 may find and remove 655 an instance of the first message from the copy queue 230 and further remove the first message from the reply queue 220.

If the detection module 330 detects 625, 635, 645 the failure of the first target node 110a, the recovery module 325 of another target node 110 may query 660 the copy queue 230 for each message stored on the copy queue 230. Although the other target node 110 may be any target node 110, for simplicity the other target node 110 is referred to herein as a second target node 110b.

The recovery module 325 further queries 665 the request queue 215 for each message on the request queue 215. The recovery module 325 determines 670 if any message such as the message of step 605 is in the copy queue 230 and not in the request queue 215. If the recovery module 325 determines 670 a message resides the copy queue 230 and also resides in the request queue 215, the recovery module 325 further determines 690 if there are additional messages to be examined in the copy queue 230. If the recovery module 325 determines 670 the message is in the copy queue 230 and not in the request queue 215, the recovery module 325 queries 675 each message table 310 of each target node 110.

The recovery module 325 determines 680 if the message resides in a message table 310 of a target node 110. If the recovery module 325 determines 680 the message does reside in a message table 310, the recovery module 325 further determines 690 if there are additional messages to be examined in the copy queue 230. If the message does not reside in the message table 310, the recovery module 325 copies 685 the message from the copy queue 230 to the request queue 215. The message copied 685 to the request queue 215 may be again transferred 620 to a target node 110.

The recovery module 325 further determines 690 if there are additional messages to be examined in the copy queue 230. If the recovery module 325 determines 690 there are no additional messages in the copy queue 230, a transfer module 320 of any target node 110 may transfer 620 the message from the request queue 215 to that target node 110. If the recovery module 325 determines 690 there are additional messages in the copy queue to be examined, the recovery module 325 loops to query 660 the copy queue 230. The method 600 recovers the message from the failed first target node 110a so that the message may be executed 630 by another target node 110.

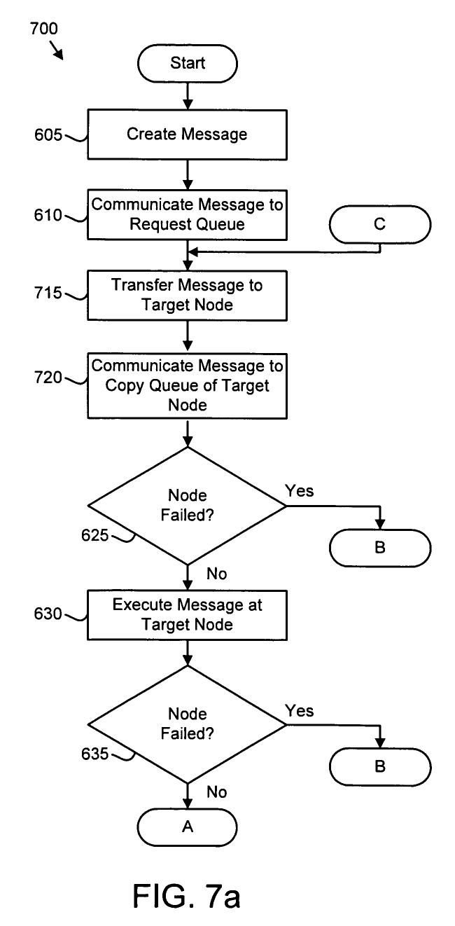

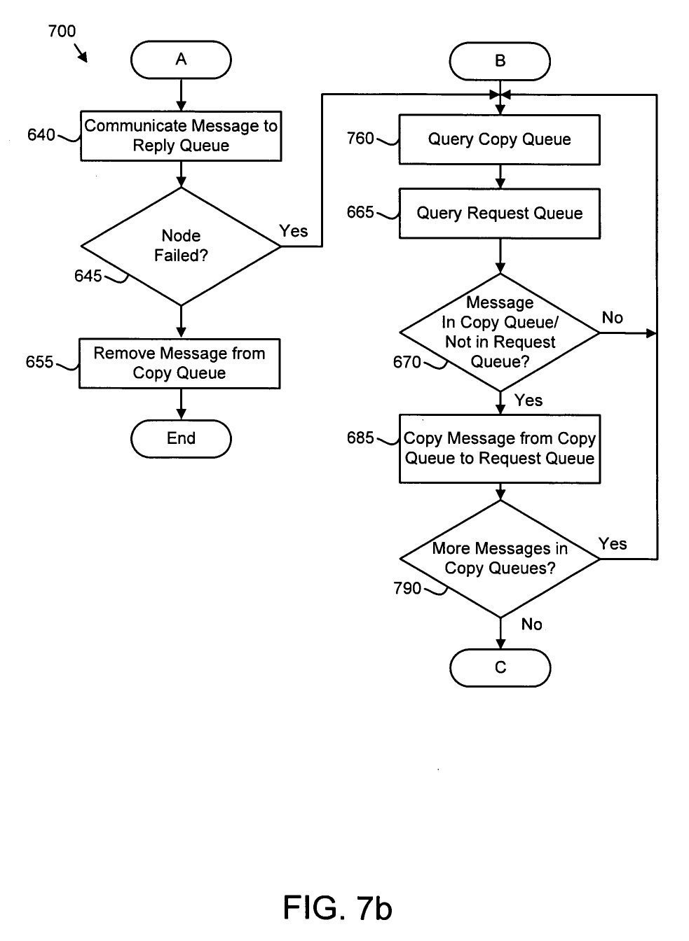

FIGS. 7a-7b are a schematic flow chart diagram illustrating one alternate embodiment of a recovery method 700 of the present invention. The method 700 substantially includes the steps to carry out the functions presented above with respect to the operation of the described system 100, nodes 105, 110, 500, and method 600 of FIGS. 1-6. an, The description of the method 700 further refers to elements of FIGS. 1-6, like numbers referring to like elements.

The method 700 begins and in one embodiment, the message module 210 creates 605 a message as described for FIG. 6. The message module 210 communicates 610 the message to the request queue 215 as described for FIG. 6.

The transfer module 320 transfers 715 the message from the request queue 215 to a first target node 110a in response to the message residing in the request queue. The transfer module 320 may read or pull the message from the request queue 215. In addition, the transfer module 320 may remove the message from the request queue 215.

In one embodiment, the message module 210 communicates 720 the message to a first copy queue 230a corresponding to the first target node 110a in response to the transfer module 320 transferring the message. For example, the message module 210 may identify the first node 110a as transferring the message and write the message to the first copy queue 230a.

The detection module 330 detects 625 if there is a failure of the first target node 110a as described for FIG. 6. If the detection module 330 does not detect 625 a failure of the first target node 110a, an execution module 315 of the first target node 110a may execute 630 the message transferred to the first target node 110a. The detection module 330 further detects 635 if there is a failure of the first target node 110a as described for FIG. 6.

If the detection module 330 does not detect 635 the failure of the first target node 110a, the execution module 315 communicates 640 the message to the reply queue 220 as described for FIG. 6. The detection module 330 detects 645 if there is a failure of the first target node 110 as described for FIG. 6. If the detection module 330 does not detect 645 the failure of the first target node 110, the message module 210 may remove 655 the message from the copy queue 230 as described for FIG. 6 and the method 700 terminates.

If the detection module 330 detects 625, 635, 645 the failure of the first target node 110a, the recovery module 325 of another target node 110 such as a second target node 110b may query 760 a copy queue 230 of the plurality of copy queues 230 for each message stored on the copy queues 230.

The recovery module 325 further queries 665 the request queue 215 for each message on the request queue 215 as described for FIG. 6. The recovery module 325 determines 670 if any message such as the message of step 605 is in the copy queue 230 and not in the request queue 215 as described for FIG. 6. If the recovery module 325 determines 670 the message is in the copy queue 230 and not in the request queue 215, the recovery module 325 copies 685 the message from the copy queue 230 to the request queue 215 as described for FIG. 6, allowing the message copied 685 to be again transferred 715 to a target node 110, recovering the message from the failed first target node 110a. If the recovery module 325 determines 670 the message is not in the copy queue 230 or in the request queue 215, the recovery module 325 loops to query 760 another copy queue 230.

The recovery module 325 further determines 790 if there are additional messages to be examined in the plurality of copy queues 230. If the recovery module 325 determines 790 there are no additional messages in the plurality of copy queues 230, a transfer module 320 of any target node 110 may transfer 620 the message from the request queue 215 to that target node 110. If the recovery module 325 determines 790 there are additional messages in the copy queue to be examined, the recovery module 325 loops to query 760 the copy queue 230. The method 700 recovers the message from the failed first target node 110a using a plurality of copy queues 230 such that the message may be executed 630 by another target node 110.

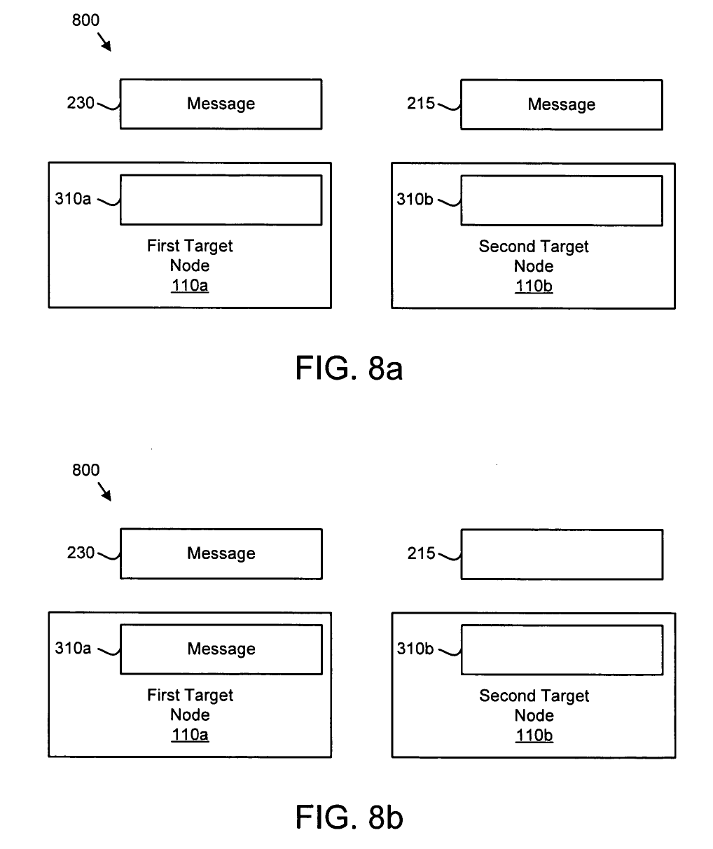

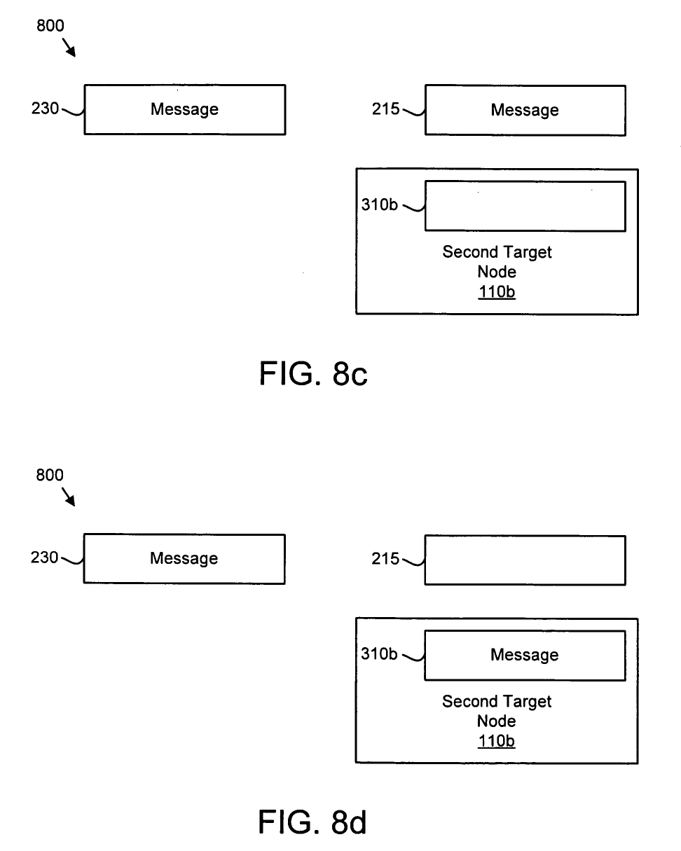

FIGS. 8a-8d are schematic block diagrams illustrating one embodiment of message recovery 800 of the present invention. The description of the recovery 800 refers to elements of FIGS. 1-7, like numbers referring to like elements. Each FIG. 8a-8d depicts the copy queue 230, request queue 215 and the second target node 110b. In addition, FIGS. 8a-8b includes the first target node 110a. Each target node 110 includes a message table 310, the first target node 110a comprising the first message table 310a and the second target node 110b comprising the second message table 310b.

Referring to FIG. 8a, the copy queue 230 and request queue 215 each include the message such as in response to the message module 210 communicating 610, 615 the message to the request queue 215 and copy queue 230 respectively. Referring to FIG. 8b, the transfer module 320 of the first target node 110a transfers 620 the message from the request queue 215 to the first message table 310a and removes the message from the request queue 215.

Referring to FIG. 8c, the first target node 110a is failed and is not depicted to show unavailablity. The detection module 330 of the second target node 110b detects 625 the failure of the first target node 110a and the recovery module 325 copies 685 the message from the copy queue 230 to the request queue 215. The message may again be transferred to a target node 110.

Referring to FIG. 8d, the transfer module 320 of the second target node 110b transfers 620 the message from the request queue 215 to the second message table 310b in response to the message not residing on the second message table 310b and any message table 310 of the plurality of message tables 310. The second target node 110b may execute 630 the message. The recovery 800 recovers the message from the failed target node 110.

The embodiment of the present invention recovers a message from a first failed target node 110a and transfers the message to a second target node 110b. In addition, the embodiment of the present invention may complete the execution of the message on the second target node 110b. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to recover messages from a failed node, the apparatus comprising:
a message module configured to communicate a message to a request queue and a copy queue wherein the message is configured as an operation for a target node of a plurality of target nodes;
a transfer module configured to transfer the message from the request queue to a first target node in response to the message residing in the request queue;
a detection module configured to detect a failure of the first target node;
a recovery module configured to copy the message from the copy queue to the request queue in response to the failure of the first target node and the message residing in the copy queue; and
the transfer module further configured to transfer the message from the request queue to a second target node in response to the message residing in the request queue.

2. The apparatus of claim 1, further comprising an execution module configured to execute the message on the second target node.

3. The apparatus of claim 2, the execution module further configured to communicate the executed message to a reply queue.

4. The apparatus of claim 1, the message module further configured to remove the message from the copy queue in response to the reply queue receiving the message.

5. The apparatus of claim 1, wherein the transfer module is further configured to transfer the message to a first message table for the first target node in response to transferring the message to the first target node.

6. The apparatus of claim 5, wherein the recovery module copies the message from the copy queue to the request queue in response to the message residing in the copy queue, not residing in the request queue, and not residing in a second message table.

7. The apparatus of claim 1, wherein the message module is further configured to communicate the message to a first copy queue for the first target node in response to the transferring the message from the request queue to the first target node.

8. The apparatus of claim 7, wherein the recovery module copies the message from the first copy queue to the request queue in response to the message residing in the first copy queue for the first target node and not residing in the request queue.

9. A signal bearing medium tangibly embodying a program of machine-readable instructions executable by a digital processing apparatus to perform an operation to recover messages from a failed node, the operation comprising:
communicating a message to a request queue and a copy queue wherein the message is configured as an atomic operation for a target node of a plurality of target nodes;
transferring the message from the request queue to a first target node in response to the message residing in the request queue;
detecting a failure of the first target node;
copying the message from the copy queue to the request queue in response to the failure of the first target node and the message residing in the copy queue;
transferring the message from the request queue to a second target node in response to the message residing in the request queue; and
executing the message on the second target node.

10. The signal bearing medium of claim 9, wherein the instructions further comprise an operation to communicate the message to a reply queue in response to executing the message.

11. The signal bearing medium of claim 10, wherein the instructions further comprise an operation to remove the message from the copy queue in response to the reply queue receiving the message.

12. The signal bearing medium of claim 9, wherein the instructions further comprise an operation to transfer the message to a first message table for the first target node in response to transferring the message to the first target node and wherein the message is copied from the copy queue to the request queue in response to the message residing in the copy queue, not residing in the request queue, and not residing in a second message table.

13. The signal bearing medium of claim 9, further comprising a copy queue for each of the plurality of target nodes and wherein the instructions further comprise an operation to communicate the message to a first copy queue for the first target node in response to the transferring the message from the request queue to the first target node and wherein the message is copied from the first copy queue to the request queue in response to the message residing in the first copy queue for the first target node and not residing in the request queue.

14. A system to recover messages from a failed node, the system comprising:
a source node configured to distribute a message and comprising
a request queue configured to store messages awaiting distribution;
a copy queue configured to store unexecuted messages;
a message module configured to communicate the message to the request queue and the copy queue wherein the message is configured as an atomic operation; and
a reply queue configure to receive an executed message; and
a plurality of target nodes each configured to execute the message and each comprising
a transfer module configured to transfer the message from the request queue to a first target node and remove the message from the request queue in response to the message residing in the request queue;
a detection module configured to detect a failure of a target node of the plurality of target nodes;
a recovery module configured to copy the message from the copy queue to the request queue in response to the failure of the first target node and the message residing in the copy queue;
the transfer module further configured to transfer the message from the request queue to a second target node in response to the message residing in the request queue; and
an execution module configured to execute the message on the second target node and communicate the message to the reply queue in response to executing the message.

15. The system of claim 14, wherein the first target node is remote from the second target node.

16. The system of claim 14, wherein the transfer module is further configured to transfer the message to a first message table for the first target node in response to transferring the message to the first target node and wherein the request module copies the message from the copy queue to the request queue in response to the message residing in the copy queue, not residing in the request queue, and not residing in a second message table for the second target node.

17. The system of claim 14, further comprising a copy queue for each of the plurality of target nodes and wherein the message module is further configured to communicate the message to a first copy queue for the first target node in response to the transferring the message from the request queue to the first target node and the recovery module copies the message from the first copy queue to the request queue in response to the message residing in the first copy queue for the first target node and not residing in the request queue.

18. A method for deploying computer infrastructure, comprising integrating computer-readable code into a computing system, wherein the code in combination with the computing system is capable of performing the following:
communicating a message to a request queue and a copy queue wherein the message is configured as an atomic operation for a target node of a plurality of target nodes;
transferring the message from the request queue to a first target node in response to the message residing in the request queue;
detecting a failure of the first target node;
copying the message from the copy queue to the request queue in response to the failure of the first target node and the message residing in the copy queue;
transferring the message from the request queue to a second target node in response to the message residing in the request queue;
executing the message on the second target node;
communicating the message to a reply queue in response to executing the message; and
removing the message from the copy queue in response to the reply queue receiving the message.

19. The method of claim 18, further comprising transferring the message to a first message table for the first target node in response to transferring the message to the first target node and wherein the message is copied from the copy queue to the request queue in response to the message residing in the copy queue, not residing in the request queue, and not residing in a second message table for the second target node.

20. The method of claim 18, further comprising a copy queue for each of the plurality of nodes, communicating the message to a first copy queue for the first target node in response to the transferring the message from the request queue to the first target node, and wherein the message is copied from the first copy queue to the request queue in response to the message residing in the first copy queue for the first target node and not residing in the request queue.
